(19) United States
(12) Patent Application Publication
(10) Pub. No.: US 2011/0176871 A1
(43) Pub. Date: Jul. 21, 2011

(54) RESERVE PIT REMEDIATION

(75) Inventors: Joseph Francis St. Pierre, Buffalo, WY (US); Shelly Ann St. Pierre, Buffalo, WY (US)

(73) Assignee: LBI, LLC, Buffalo, WY (US)

(21) Appl. No.: 13/006,203

(22) Filed: Jan. 13, 2011

Related U.S. Application Data
(60) Provisional application No. 61/295,304, filed on Jan. 15, 2010.

(51) Int. Cl. B09C 1/00; B01J 20/22

(52) U.S. Cl. 405/128.5; 405/128.7; 502/401

(57) ABSTRACT

Reserve pit remediation utilizing an organic absorbent product made from beetle-killed lodgepole pine. The reserve pit remediation may take place in-situ, ex-situ, or a combination of both in-situ and ex-situ. In one embodiment of an in-situ reserve pit remediation process, one or more of a volume of water within the pit, a volume of fluids other than water within the pit, and a volume of solids within the pit are estimated, a quantity of absorbent product to be distributed within the pit is determined based on one or more of the estimated volumes, the quantity of absorbent product is distributed over the surface of the reserve pit, a period of time for the absorbent product to absorb at least a portion of the fluids other than water is allowed, and the absorbent product is mixed with the solids within the reserve pit. In one embodiment, the ex-situ reserve pit remediation process includes removing at least a portion of the contents of the pit, placing the removed pit contents into a container, and mixing a quantity of absorbent product with the removed contents in the container. The absorbent product may, for example, comprise fractured portions of pellets made from beetle-killed lodgepole pine that have been screened to select only portions of a desired size (e.g. ranging in size from about ⅛ to about ¼ of an inch).

### RELATED APPLICATION INFORMATION

This application claims priority from U.S. Provisional Application Ser. No. 61/295,304, entitled “ORGANIC ABSORBENT PRODUCT AND METHOD” filed on Jan. 15, 2010, which is incorporated by reference herein in its entirety.

### BACKGROUND OF THE INVENTION

Oil and gas well drilling operations often utilize one or more adjacent reserve pits to temporarily store various fluids and solids that are produced during the drilling operation or injected during the drilling operation and subsequently ejected from the well. Examples of such fluids and solids stored in a reserve pit include water, petroleum hydrocarbon, various chemicals injected during a fracturing process (often referred to as fracturing fluids), and drilling mud and other spoils. Such contents generally settle into various layers within the reserve pit (e.g., a layer of water, a layer of fluids other than water, and a layer of solids).

The reserve pit(s) are typically dug adjacent to the drill site and lined with a membrane intended to prevent the contents from being absorbed into or mixing with the surrounding ground. When the drilling operation is completed, it is desirable, and typically required by regulatory authorities, that the reserve pit be closed. One manner of closing reserve pits involves physically removing the various fluids and solids from the reserve pit, backfilling the reserve pit with soil, and transporting the removed pit contents to a remote disposal site. Often the removed pit contents are treated with fly ash prior to disposal of the removed pit contents. Thus, closing reserve pits in this manner involves an expensive removal and transportation process that presents the possible hazard of spilled pit contents during transportation and treatment of the removed pit contents with a fly-ash that is derived as a by-product of coal burning power plants.

Another manner of closing open reserve pits involves removing excess fluid and mixing the pit contents with fly ash. Once the mixed contents solidify, the pit is then reclaimed. Thus, closing an open reserve pit in this manner involves the use of a regulated hazardous waste, fly ash, which is left in the environment.

Western North American forests include a great deal of lodgepole pine (pinus contorta), much of which suffers from an ongoing infestation of the Mountain Bark Beetle (Dendrocotonus Ponderosae). Large swaths of lodgepole pine forests are either already dead or dying as a result of the beetles, and these stands of dead or dying timber present a significant fire and animal habitat hazard.

### SUMMARY OF THE INVENTION

Accordingly, the present invention provides an organic absorbent product prepared from beetle-killed lodgepole pine that may be utilized in a number of applications including, in accordance with the present invention, to remediate and solidify the contents of a reserve pit. More particularly, the contents of a reserve pit may be remediated and solidified in-situ using the absorbent product thereby eliminating the need to remove, transport and remotely treat reserve pit content. The contents of a reserve pit may also be remediated and solidified ex-situ within, for example, a container using the absorbent product. Because the absorbent product used to treat the reserve pit contents is derived from a widely and readily available beetle-killed lodgepole pine, the present invention also presents the advantage of utilizing a heretofore underutilized, naturally occurring and renewable resource.

In one aspect, a method for in-situ remediation of a reserve pit may include the step of estimating one or more of a volume of water within the pit, a volume of fluids other than water within the pit, and a volume of solids within the pit. The in-situ reserve pit remediation method also may include the step of determining a quantity of absorbent product to be distributed within the pit based on one or more of the estimated volume of water, estimated volume of fluids other than water and estimated volume of solids, wherein the absorbent product comprises fractured portions of pellets made from beetle-killed lodgepole pine. The in-situ reserve pit remediation method also may include the step of distributing the quantity of absorbent product over the surface of the reserve pit. The in-situ reserve pit remediation method may also include the step of waiting a period of time for the absorbent product to absorb at least a portion of the fluids other than water. The in-situ reserve pit remediation method may also include the step of mixing the absorbent product with the solids within the reserve pit.

In a further aspect, a method for in-situ remediation of a reserve pit may include the steps of distributing a quantity of an absorbent product over the surface of the reserve pit, wherein the absorbent product comprises fractured pellets made from various portions of beetle-killed lodgepole pine, and mixing the absorbent product with the contents of the reserve pit.

In another aspect, an organic absorbent product for use in in-situ and/or ex-situ reserve pit remediation comprises fractured portions of pellets made from beetle-killed lodgepole pine, wherein the fractured portions range in size from about ⅛ inch to about ¼ inch. The fractured portions may be electrostatically charged. The pellets from which the fractured portions are obtained may have been compressed to a density in the range of about 40 to 46 pounds per cubic foot and may have a maximum moisture content of less than or equal to about 6 percent by weight. The pellets from which the fractured portions are obtained may be made from various portions of beetle-killed lodgepole pine, including, for example, at least one of the bark, the trunk, larger branches, sawdust and chips. The portions of beetle-killed lodgepole pine from which the pellets are made may, for example, exclude small branches and needles.

In yet another aspect, a method for ex-situ remediation of a reserve pit may include the step of removing at least a portion of the contents of the reserve pit. The ex-situ reserve pit remediation method may also include placing the removed contents of the reserve pit in a container. The ex-situ reserve pit remediation method may also include placing a quantity of an absorbent product in the container, wherein the absorbent product comprises fractured pellets made from various portions of beetle-killed lodgepole pine. The ex-situ reserve pit remediation method also may include mixing the absorbent product with the removed contents of the reserve pit within the container.

In one more aspect, both in-situ and ex-situ remediation methods may be employed in combination to remediate the contents of the same reserve pit.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 shows the steps of one embodiment of preparing an organic absorbent product particularly for use as an animal litter;

FIG. 2 shows the steps of another embodiment of preparing an organic absorbent product particularly for use in absorbing and remediating spilled petroleum hydrocarbons on water;

FIG. 3 shows the steps of another embodiment of preparing an organic absorbent product particularly for use in absorbing and remediating spilled petroleum hydrocarbons on land and in soils;

FIG. 4 is a photographic image of pellets made from various portions of beetle-killed lodgepole pine;

FIG. 5 is a photographic image of the organic absorbent product made from various portions of beetle-killed lodgepole pine in the form of fractured pellets made from the pellets of FIG. 4;

FIG. 6 is a photographic image of the organic absorbent product in which the organic absorbent product fractured pellets of FIG. 5 have been screened to select fractured pellets within a range of desired sizes;

FIG. 7 is a photographic image showing the organic absorbent product having been used to absorb a quart of oil from a concrete floor;

FIG. 8 is a photographic image showing grass growing in alkaline soil that has been mixed with new organic absorbent product and organic absorbent product that has already been used to absorb oil in a ratio of 10 parts soil to 1 part new absorbent product and 1 part used absorbent product;

FIG. 9 is a photographic image showing grass growing in alkaline soil that has been mixed with new organic absorbent product in a ratio of 1 part soil to 1 part new absorbent product;

FIG. 10 shows one embodiment of an in-situ reserve pit remediation process that utilizes an organic absorbent product made from beetle-killed lodgepole pine;

FIG. 11 is a photographic image showing an exemplary reserve pit adjacent to a drilling operation and having various contents contained within the pit;

FIG. 12 is a photographic image showing a bulk bag of absorbent material being prepared for attachment to the bucket of an excavator;

FIG. 13 is a photographic image showing absorbent material being distributed from the bulk bag over the surface of the pit;

FIG. 14 is a photographic image showing a high shear mixing device attached to the bucket of an excavator for positioning in the pit;

FIG. 15 is a photographic image showing the high shear mixing device being used to mix absorbent material and pit contents;

FIG. 16 is a photographic image showing a pair of excavators being used to place and mix backfill soil with the contents of the pit; and

FIG. 17 shows one embodiment of an ex-situ reserve pit remediation process that utilizes an organic absorbent product made from beetle-killed lodgepole pine.

### DETAILED DESCRIPTION

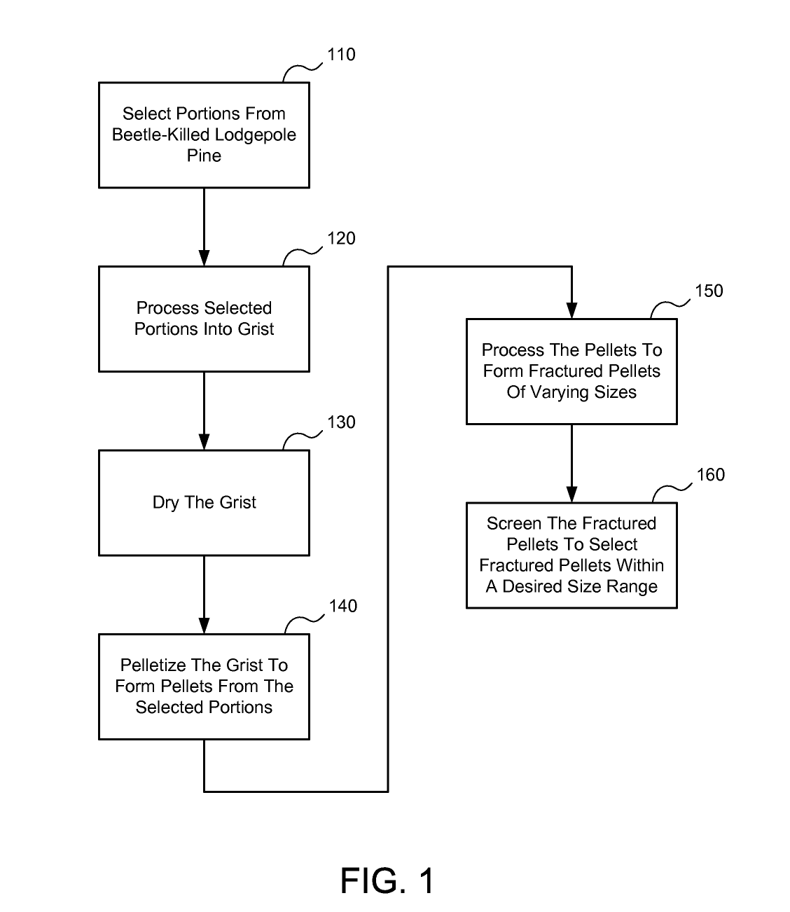

FIGS. 1-3 show the steps involved in various embodiments of a method of making an organic absorbent product from beetle-killed lodge pole pine. The absorbent product prepared in accordance with the methods of FIGS. 1-3 may be in the form of wood fiber fractured pellets or small pieces and fines or small particles depending upon its intended application.

When appropriately prepared such as illustrated in FIGS. 1-3, the absorbent product is useful in various applications including, for example, as an animal litter, as a petroleum hydrocarbons spill absorbent, as a hydrocarbon remediation tool, as a floor sweeping material, as a hand cleaner, and for oil control. The absorbent product absorbs many known types of liquids and fluids including urine, feces, and also any oleaginous fluids. The absorbent product also absorbs fluids of multiple viscosities, stops or suppresses hazardous and non hazardous fumes that may or may not contain bio-hazards for safe removal, suppresses ignitable fumes providing a safer environment for first responders, and solves a problem of cleaning oil or DRO/GRO contaminated dirt in-situ without removal of the dirt. The absorbent product removes petroleum hydrocarbon based products from fresh water and salt water surfaces and absorbs surface hydrocarbons from related spills of gas or other explosive liquids, all resulting in the reduction for the potential of an ignition or explosion. The absorbent product neutralizes alkali from surface neutralizing salt content of clay based soils, providing for increased agricultural growth of plant life in previously once useless or unusable soils. The absorbent product also removes odors from skin caused by onion, garlic, gas, oil, diesel fuel, fecal matter, plant life, and all other hard to remove smells associated with everyday living. The absorbent product removes smells from air, from dirt, garbage cans, and from hair. The absorbent product also removes oil from carpet, removes oil from birds and other animals caught in an oil disaster, cleans steel and power tools of oil, and cleans oil from concrete, asphalt, and any hard surface. The absorbent product works as a floor sweep, works as a lubricant, removes dried oil from driveway or any hard surfaces, as bio-litter for cats and bedding for small animals, and as bio-litter for all types of small animals. The absorbent product is also capable of rapidly and efficiently absorbing animal excretions and, minimizing unpleasant odors. The addition of urine from animals when added by the animal to the absorbent product helps increase the growth of beneficial microorganisms increasing the likelihood for the removal of fecal matter or consumption thereof, also repelling certain types of insect pests from areas of a home, and other important nutrients to soil when used as a mulch. The absorbent product will also absorb water in hard to reach places in a flooded environment where water can't be reached by normal methods.

In general, the absorbent product may be produced by initially selecting (only) beetle-killed lodgepole pine for further processing. After selection of only beetle-killed lodgepole pine, the method may involve combining and admixing various portions of ground and dried beetle-killed lodge pole pine to form admixed grist, moistening the admixed grist, pelletizing the grist, and grinding the pellets to form wood fiber fractured pellets or small pieces. One or more additional steps may be undertaken depending upon the intended application of the absorbent product. During production, dust may be removed by vacuum throughout the entire process.

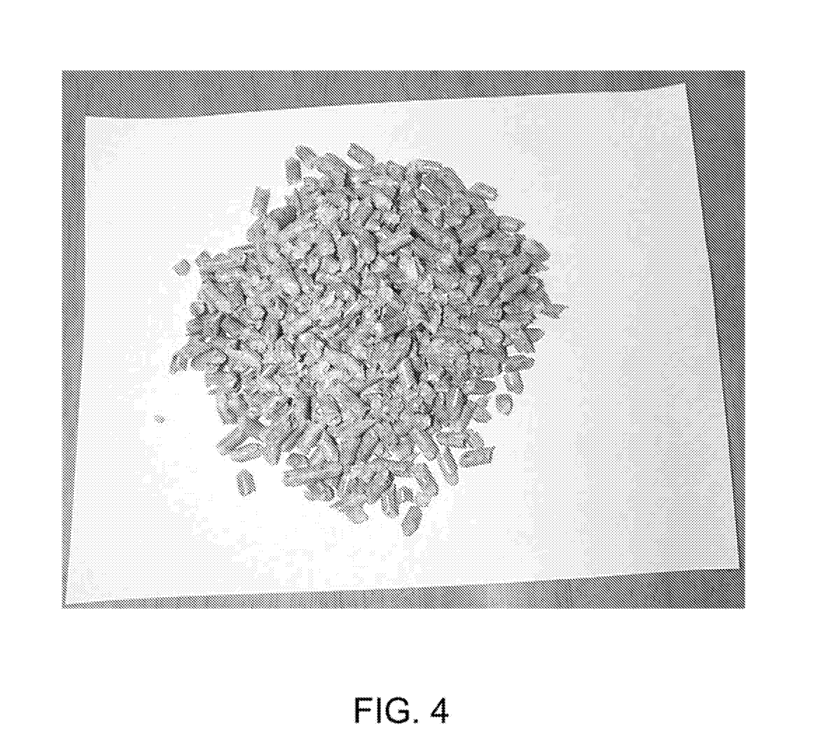

When it is desired to use the absorbent product as an animal litter, the absorbent product may be prepared as shown in FIG. 1. Various portions such as, for example, bark, sawdust, the trunk, larger branches and/or chips of wood are selected (110) from beetle-killed lodge pole pine. In this regard, small branches and remaining needles, if any, still on the dead tree may be excluded. The selected portions of the beetle-killed lodgepole pine are processed (120) into grist. In this regard, the selected portions may, for example, be sent into a hammer mill and hammered to fine grist. The grist is then dried (130). In this regard, the grist may, for example be dried by heating the grist until it reaches desired moisture content. The desired moisture content may, for example, be maximum moisture content of less than or equal to about 6% by weight. After the drying process, the grist is pelletized (140). The grist may be pelletized in a conventional feed pelletizer. As part of the pelletizing process (140) the grist may, for example, be remoistened to 12 percent to 16 percent moisture content by weight. The size of the pellets produced is unimportant. FIG. 4 shows an example of such pellets.

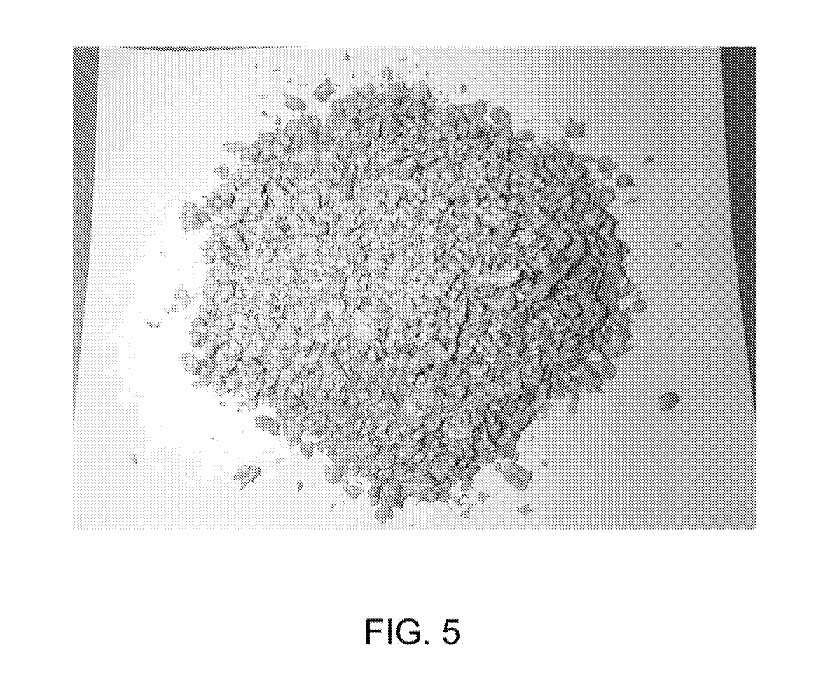

The pellets are processed (150) to form fractured pellets or small pieces of varying sizes. In this regard, the pellets may be ground in a pellet grinder. For example, full pellets may be added to a first hopper, a five hp vacuum may be turned on, and the pellets are conveyed from the first hopper by a three inch circular screw conveyer to a pellet grinder that is set to grind the pellets to a size no less than a desired minimum size. FIG. 5 shows an example of such fractured pellets.

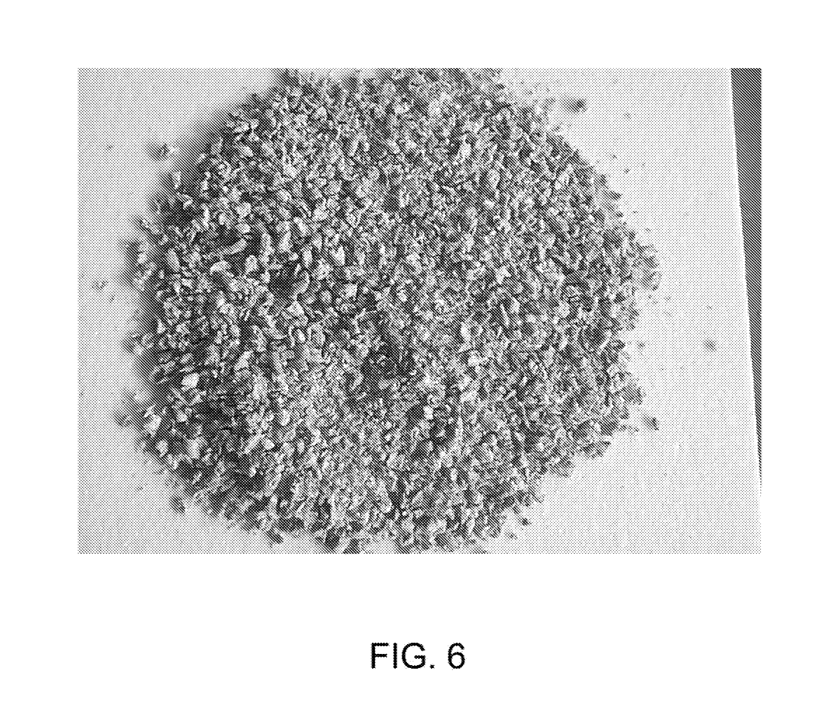

For use as animal litter (and for some other uses described herein), the fractured pellets preferably are of a size between a minimum desired size and less than a maximum desired size. In this regard, the fractured pellets may range from about one-eighth (⅛) to about one quarter (¼) inch in size. Accordingly, in the preferred embodiment, the fractured pellets are next screened (160) through a series of vibrating screen tables to select fractured pellets within the range of the desired minimum and maximum dimensions. For example the fractured pellets may be first screened using a screen with nominal ⅛ inch holes to select fractured pellets about ⅛ inch in size or greater and thereafter the selected fractured pellets are then screened using a screen with nominal ¼ inch holes to separate larger fractured pellets exceeding about ¼ inch. Of course, in the screening process (160), the order of the screens may be reversed to achieve the same selection, or fewer or more than two screens may be employed depending upon the size selection that is desired. FIG. 6 shows an example of screened fractured pellets.

In one particular embodiment, the screening process (160) may involve: dropping the fractured pellets onto table that is four feet by ten feet, with a screen that has holes one-eighth inch separated by one-sixteenth inch; operating a one hp vibco vibration motor attached to the screen and a three quarter hp vibco vibration motor attached to the table, the vibration sending the ground pellets, or small pieces or fractured pellets downward toward a v-shaped collector at the bottom of the table; selecting and collecting the small pieces or fractured pellets after vibration that are larger than one eighth-inch and less than one quarter inch, broken and or chipped; sending fine dust smaller than one thirty-second in size that is removed as a result of the vibration to a holding tank for future use as products; collecting the fractured pellets in the base of a three inch circular screw conveyor that conveys the screened fractured pellets to a second hopper; statically charging the fractured pellets; weighing the fractured pellets by a Hammer brand scale; and dropping the fractured pellets through a chamber to a Hammer brand bagging machine.

After screening, the larger fractured pellets (e.g., those with dimension larger than the maximum desired size) are acceptable for further processing and may be ground again in the pellet grinder and proceed through further screening for selection of appropriate sized fractured pellets. The wood fiber fractured pellets so produced are desirable as it has been found that they generally absorb liquid far more quickly and in greater volume than do the pellets as a whole. To reduce wood fiber dust, during the production process dust is preferably vacuumed away from the fractured pellets during or after the final screening. The dust may be used in other products described herein.

Although the beetle-killed lodge pole pine generally provides the absorbent product with a pleasant aroma, some might be inclined to enhance the aroma of the wood fiber fractured pellets with the addition of aromatic additives (e.g., certain perfumes and/or oils). However, the present method preferably avoids the addition of aromatic additives to the wood fiber fractured pellets because, in many applications, the growth of microorganisms is desired when using the absorbent product and such growth helps with the reduction of smells as well as the remediation benefits of the absorbent product described herein, but the addition of aromatic additives could impede this microorganism growth process. Further, when using the absorbent product as an animal litter for common household pets, the wood fiber fractured pellets are preferably spread to a height of 2 inches or more.

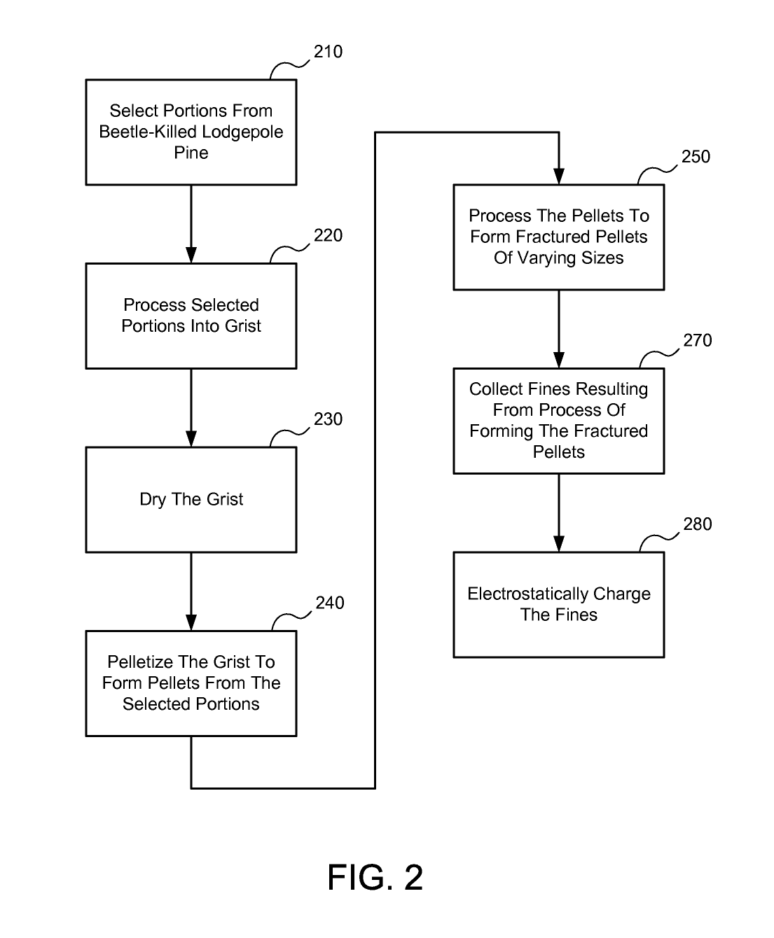

When it is desired to use the absorbent product for absorbing petroleum hydrocarbons for example to clean up a petroleum hydrocarbon spill at sea, the absorbent product may be prepared as shown in FIG. 2 to a finite product finer than flower. The preparation process again begins with the selection (210) of various portions such as, for example, bark, sawdust, and/or chips of wood from beetle-killed lodge pole pine and proceeds as with the process of preparing the absorbent product for use as animal litter shown in FIG. 1 through the step of processing (250) the pellets to form fractured pellets or small pieces of varying sizes. Thereafter, fine dust or fines resulting from the process (e.g., grinding) that is used to form fractured pellets from the pellets is collected (270). The fine dust is a secondary product which is an offset from the fractured pellets and additional grinding is typically not needed to obtain the fines. In this regard, the fines may be comprised of particles as small as about one-thirty second in particle size, and no larger than about one-sixteenth in particle size. An electrostatic charging process (280) is then being applied to the ultra-fine dust particles through the entire process from hopper to bagger or finished product.

In use, absorbent product comprised of statically charged fines is sprinkled on spilled petroleum hydrocarbon crude or otherwise whether it is floating on fresh or salt water. Once on top of the oil, a reaction occurs with the absorbent product fines. The reaction causes the petroleum hydrocarbon to coagulate thereby facilitating easy removal of globs of petroleum hydrocarbon leaving a clean surface. The coagulated oil may be collected and sent to a processing plant for possible further processing. Also any remaining oil that sinks to the bottom will remediate and dissipate within 3 to 6 months after application of the absorbent product fines.

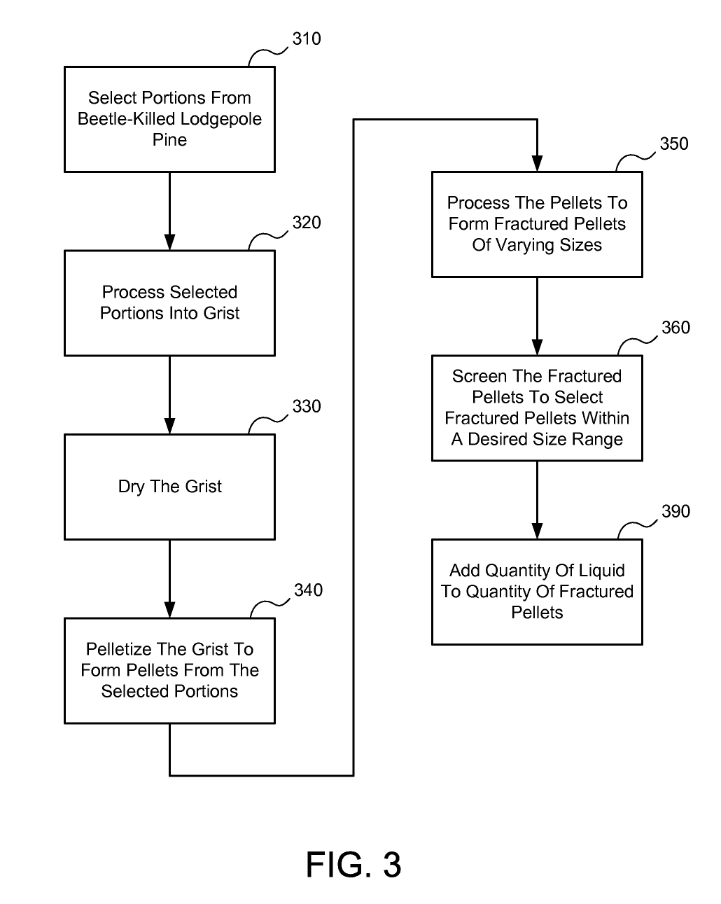

When it is desired to use the absorbent product for absorbing and remediating petroleum hydrocarbon on land surfaces and in soils, the absorbent product may be prepared as shown in FIG. 3. The preparation process again begins with the selection (310) of various portions such as, for example, bark, sawdust, and/or chips of wood from beetle-killed lodge pole pine and proceeds as with the process of preparing the absorbent product for use as animal litter shown in FIG. 1 through the step of screening (360) the fractured pellets or small pieces to select fractured pellets within the range of desired minimum and maximum dimensions for the application.

Prior to using the absorbent product for absorbing and remediating petroleum hydrocarbon (including hydrocarbons, diesel range organics (DROs), and gasoline range organics (GROs)) on land surfaces and in soils, the additional step of adding (390) an activating liquid such as, for example, water may be undertaken. The addition of water quickens the remediation of the oil by helping the growth of desired microorganisms, and is a determining factor with the reduction and remediation of hydrocarbons, DROs and/or GROs within a short period of time (e.g., 2 to 12 hours). The step of adding (390) an activating liquid is most desirably performed immediately prior to application of the absorbent product, though water might be added earlier in particular application situations as stated, during application or after application. The addition of water is a desirable part of the remediation process, as without its introduction remediation may take anywhere from 9 to 12 months.

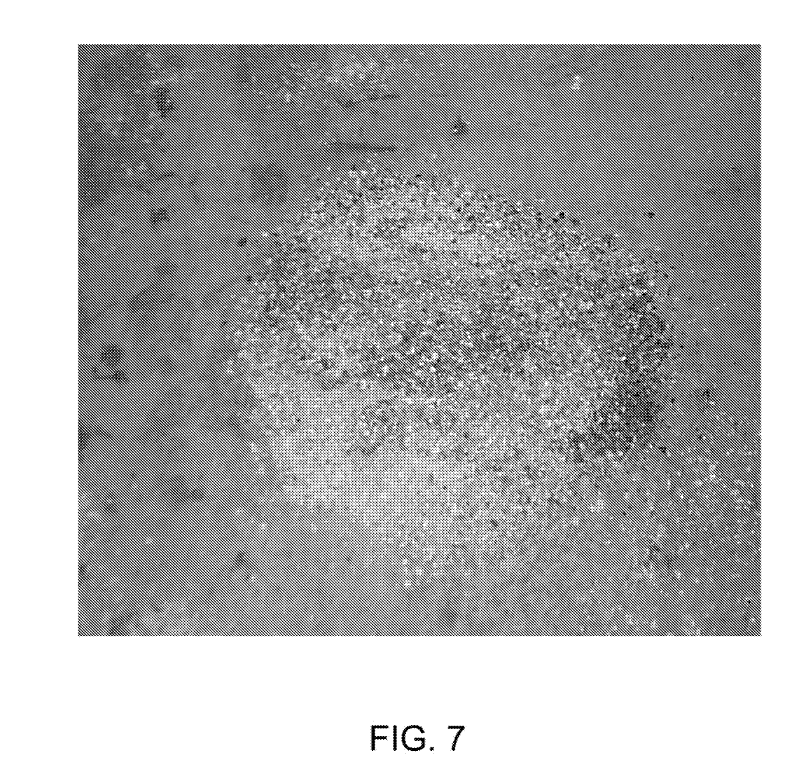

When it is desired to use the absorbent product as a floor sweeping material capable of absorbing aqueous and oleaginous liquid or fluid spills, for example, water, gasoline, engine oil, etc., the absorbent product may be prepared in essentially the same manner as preparing the absorbent product for absorbing and remediating petroleum hydrocarbon shown in FIG. 3. Preferably, in making fractured pellets for floor sweeping material, fractured pellets of pelletized grist of beetle-killed lodge pole pine may be combined in any desired proportions and size as described above. A light sprinkle of the fractured pellets on a floor is all that is needed as this material will absorb 100 percent to 400 percent of its own weight in moisture. Where a remediating effect is particularly desired, prior to sprinkling the absorbent product, the step of adding an activating liquid (e.g., water or light canola oil) may be undertaken to activate the microbes that remediate. When wanting to control dust canola oil may be added at a ratio of 1 ounce canola oil per 1 pound of absorbent product. FIG. 7 shows an example of the absorbent product used as a floor sweeping material to absorb oil.

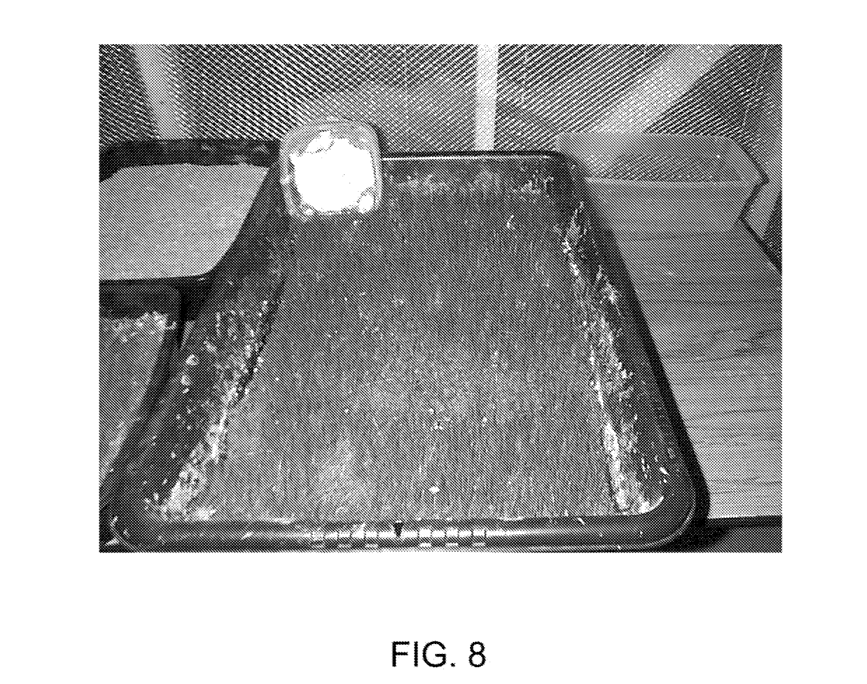

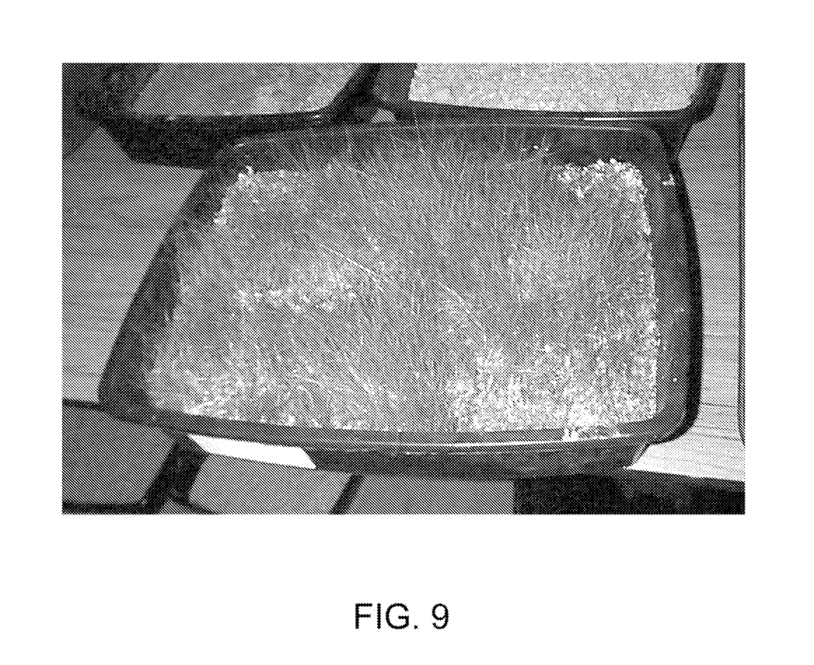

When it is desired to use the absorbent product for enrichment of soil, including the neutralization of alkaline soils, the absorbent product may be prepared in essentially the same manner as preparing the absorbent product for absorbing and remediating petroleum hydrocarbon shown in FIG. 3. When used as mulch to neutralize alkaline soils, new absorbent product and/or also used oil remediated absorbent product can be added to the soil. In this regard, water may be added (390) in a ratio of one part water to one part new absorbent product to help with the microbial growth process, and when used product is added water may also be introduced to aid the process. FIGS. 8 and 9 show examples of new and used absorbent product mixed with alkaline soil in order to neutralize the alkaline soil thereby promoting the growth of vegetation on the heretofore barren soil.

When it is desired to use the absorbent product as a hand and skin cleaner, the absorbent product may be prepared in essentially the same manner as preparing the absorbent product for absorbing and remediating petroleum hydrocarbon shown in FIG. 3. When used as a hand and skin cleaner, wetting of the absorbent product with an activating liquid (e.g., water) prior to rubbing a quantity of the absorbent product on hands or other skin in need of cleaning may be desirable, particularly if the hands or skin are not moist prior to application of the absorbent product. Additionally, a quantity of the absorbent product that has been pre-mixed with an activating liquid (e.g., water) and stored in a container may be dispensed there from and used as a hand and skin cleaner.

Accordingly, in view of the previously described embodiments it is seen that preparation of an admixture of grist of various portions of beetle-killed lodge pole pine followed by a sequence of steps including one or more of the following: drying, pelletizing, grinding the resultant pellets to form fractured pellets, collecting fines resulting from grinding of the pellets, screening for the desired range of sizes of fractured pellets, electrostatic charging of the fines, and moistening with an activating liquid, yields an absorbent product with the desired characteristics that have been described herein. Depending upon the amount used, these characteristics include rapid and efficient absorption of animal excretions or of petroleum hydrocarbon spills, the remediation of oil from land surfaces and soils, substantial elimination of unpleasant odors from hands, floors, closets, dirt under homes and the growth of microorganisms that also play into all of the claims. It will remove oil from water and leave the aquatic life free from oil or contaminates bringing no harm to fowl.

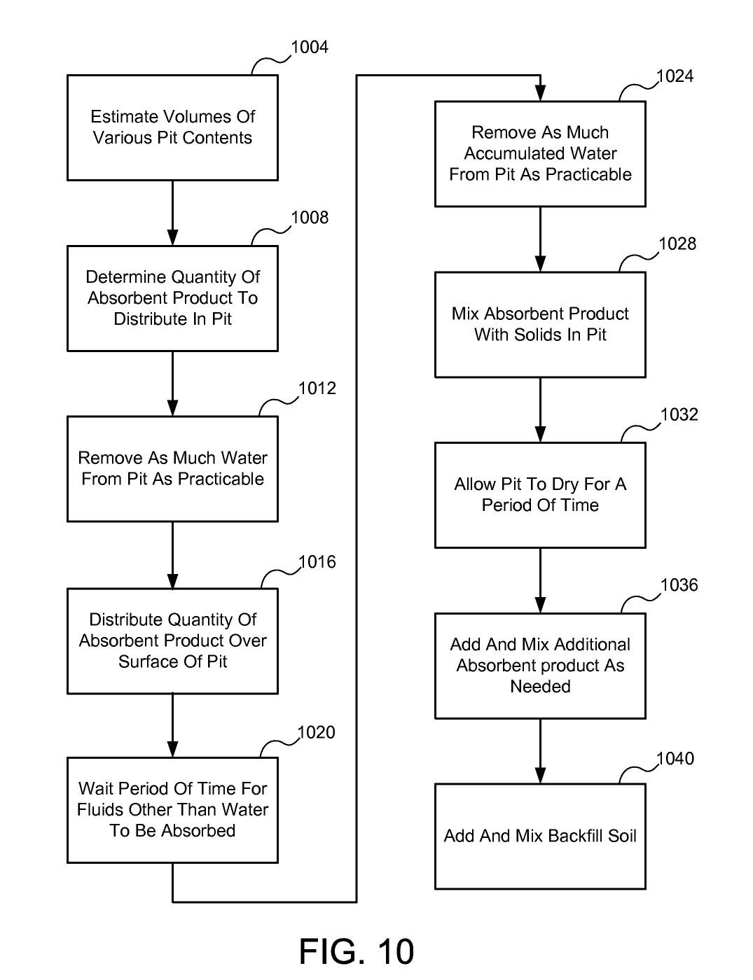

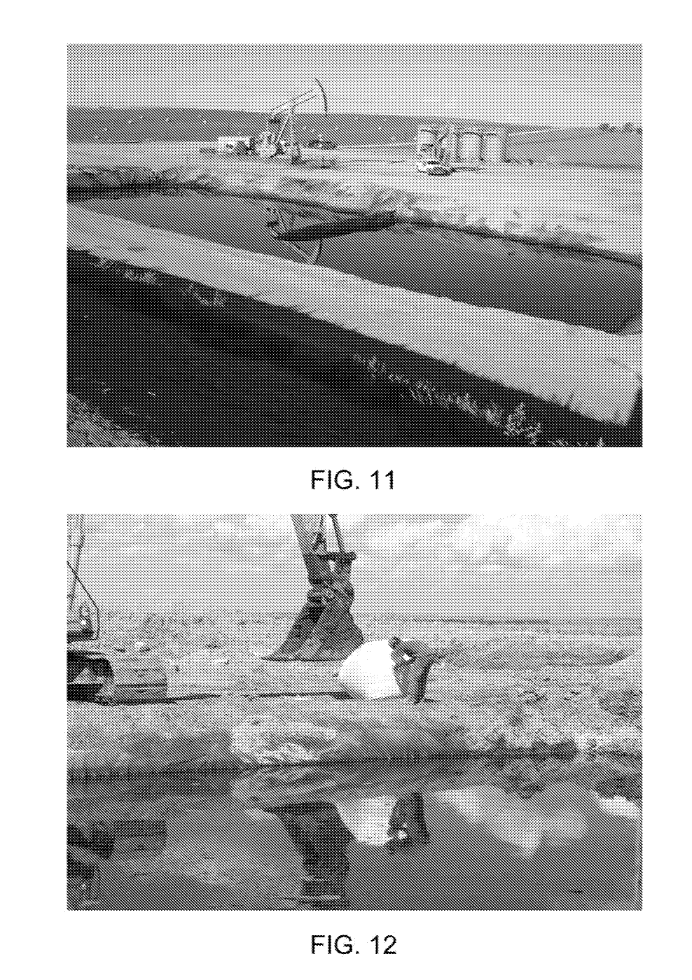

FIG. 10 depicts one embodiment of an in-situ reserve pit remediation process (1000) that utilizes an organic absorbent product made from beetle-killed lodgepole pine to remediate and solidify to contents of a reserve pit. FIG. 11 depicts an exemplary reserve pit adjacent to a drilling operation and having various contents contained within the pit.

The absorbent product may comprise fractured portions (also referred to herein as fractured pellets or small pieces) of pellets made from beetle-killed lodgepole pine. In this regard, the absorbent product may, for example, be prepared in a manner consistent with steps (310) through (360) of the process depicted in FIG. 3, although other preparation processes may also be sufficient. Additionally, in preparing the absorbent product for use in the in-situ reserve pit remediation process (1000), it may, for example, be desirable to electrostatically charge the fractured portions prior to use.

The in-situ reserve pit remediation process (1000) includes the step of estimating (1004) the volumes of the various contents of the pit. In this regard, three different volumes may desirably be estimated including the volume of water within the pit, the volume of fluids other than water (e.g., petroleum hydrocarbon and fracturing fluids) within the pit, and the volume of solids (e.g. drilling mud and spoils) within the pit. The various volumes of pit contents may, for example, be estimated by establishing a total volume of the pit, measuring the depths of water within the pit, the fluids other than water within the pit, and the solids within the pit, and using the measured depths and the total volume of the pit to determine the volumes of water within the pit, the fluids other than water within the pit, and the solids within the pit.

The in-situ reserve pit remediation process (1000) also includes the step of determining (1008) a quantity of absorbent product to be distributed within the pit. In this regard, the a quantity of absorbent product to be distributed within the pit may be determined (1008) based on one or more of the estimated volume of water, estimated volume of fluids other than water and estimated volume of solids. For example, Table 1 sets forth desirable recommended and maximum ratios of various pit contents to quantities of absorbent product to be distributed within the pit.

TABLE 1

| Material To | | |
|---|---|---|
| be Absorbed | Recommended Ratio | Maximum Ratio |
| Water | 12 barrels per bulk bag | 30 barrels per bulk bag |
| Fracturing | 13.5 barrels per bulk bag | 25 barrels per bulk bag |
| Fluid | | |
| Drilling Mud | 5 cubic yards per bulk bag | 8 cubic yards per bulk bag |
| and Spoils | | |

In Table 1, a bulk bag of absorbent product is assumed to contain approximately 2.33 cubic yards of absorbent product and a barrel is assumed to contain approximately 42 gallons. It should be noted the ratios set forth in Table 1 are general guidelines, and that due to specific circumstances (e.g. the varying nature of fracturing chemicals employed at a specific drilling site), the ratios may need to be varied accordingly. In any event, it is desirable that the volume of dry absorbent product plus the estimated volume of the solids within the pit not exceed one-half of the total pit volume since the absorbent product may expand approximately 2.5 to 3 times its dry volume when hydrated.

The in-situ reserve pit remediation process (1000) may also include the step of removing (1012) as much of the water from the pit as is practicable. In this regard, removal of water from the pit should be accomplished in a manner that minimizes or avoids the amount of fluids other than water (e.g., petroleum hydrocarbon and fracturing fluids) that are removed. In some circumstances (e.g., when it is too difficult to remove only water from the pit or when the amount of water in the pit is minimal), step (1012) need not be included in the reserve pit remediation process (1000).

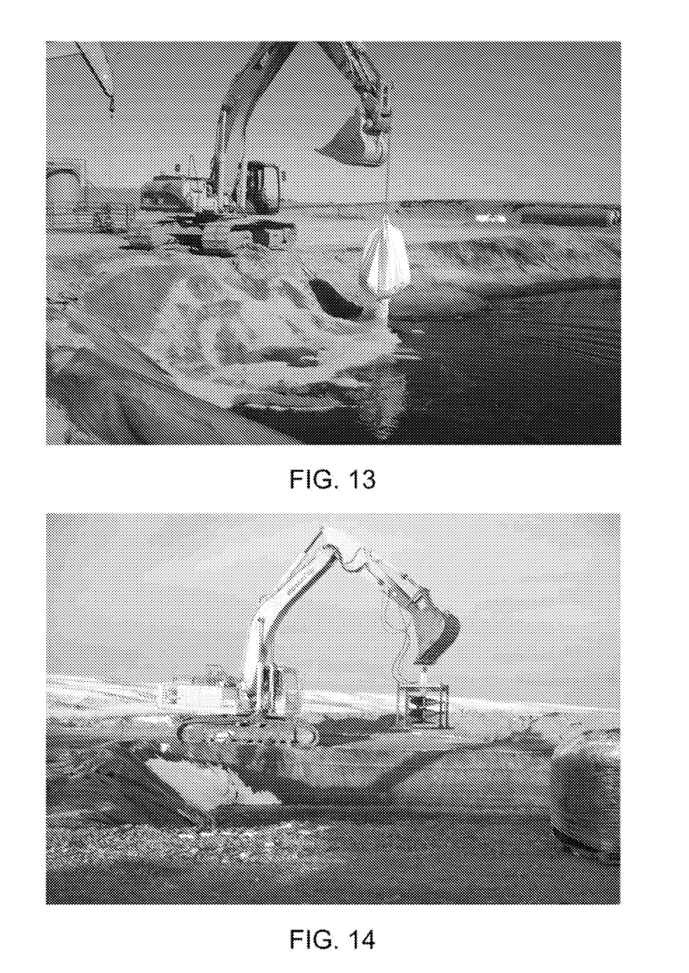

The in-situ reserve pit remediation process (1000) also includes the step of distributing (1016) the quantity of absorbent product over the surface of the reserve pit. Where the absorbent product is delivered to the drilling site location in bulk bags having a snorkel and loops fixed thereto, the absorbent product may, for example, be distributed by attaching a bulk bag to the bucket of an excavator with a suitably strong lift strap running through the loops, opening the snorkel, and operating the excavator bucket to lift and move the bag over the surface of the pit. FIG. 12 depicts a bulk bag of absorbent material being prepared for attachment to the bucket of an excavator, and FIG. 13 depicts the absorbent material being distributed from the bulk bag over the surface of the pit.

When distributing (1016) the quantity of absorbent product, dust emissions may be reduced by keeping the snorkel no more than a preferred distance (e.g., approximately 3 feet) from the surface of the pit. In distributing (1016) the absorbent product, it is desirable that the quantity of absorbent product in general be evenly distributed over the entire surface of the reserve pit. In this regard, where the pit is too large for the equipment being used to reach the entire surface of the pit from its edges, the pit may need to be sub-divided into portions (e.g. halves, thirds, quarters, etc.) with backfill soil prior to commencing distribution of the absorbent product so that the excavator or other equipment being used to distribute the absorbent product can be moved to locations within the outer perimeter of the pit in order to evenly distribute the absorbent product. Where the pit is sub-divided into portions, the determined quantity of absorbent product should also be accordingly sub-divided.

The in-situ reserve pit remediation process (1000) may also include the step of waiting (1020) a period of time after the step of distributing (1016) for the absorbent product to absorb at least a portion of the fluids other than water within the pit. While the amount of time to wait may vary, it will typically be sufficient to wait for a period of as long as two days before proceeding with further steps of the reserve pit remediation process (1000). In some circumstances (e.g. when the amount of fluids other than water within the pit is minimal or the ambient temperature is >50 deg. F.), the period of time to wait may be significantly shorter than two days (e.g. one day or even less).

After waiting for at least a portion of the fluids other than water to be absorbed by the absorbent product, the reserve pit remediation process (1000) may include the step of removing (1024) as much accumulated water from the surface of the pit as is practicable. While the absorbent product will absorb water, it has an affinity for organic fluids other than water and thus will preferentially absorb fracturing fluids and petroleum hydrocarbons within the pit. Having absorbed fracturing fluids and petroleum hydrocarbons, the saturated absorbent product is heavier than water and therefore sinks Water underlying the fracturing fluid and petroleum hydrocarbons may rise above the saturated absorbent product. Water in the mud at the bottom of the pit may also be displaced due to the weight of the saturated absorbent product and may rise above the saturated absorbent product. Removal of such accumulated water from the pit should be accomplished in a manner that minimizes or avoids the amount of fluids other than water (e.g., petroleum hydrocarbons and fracturing fluids) that are removed. In some circumstances (e.g., when it is too difficult to remove only accumulated water from the pit or when the amount of accumulated water is minimal), step (1024) need not be included in the reserve pit remediation process (1000).

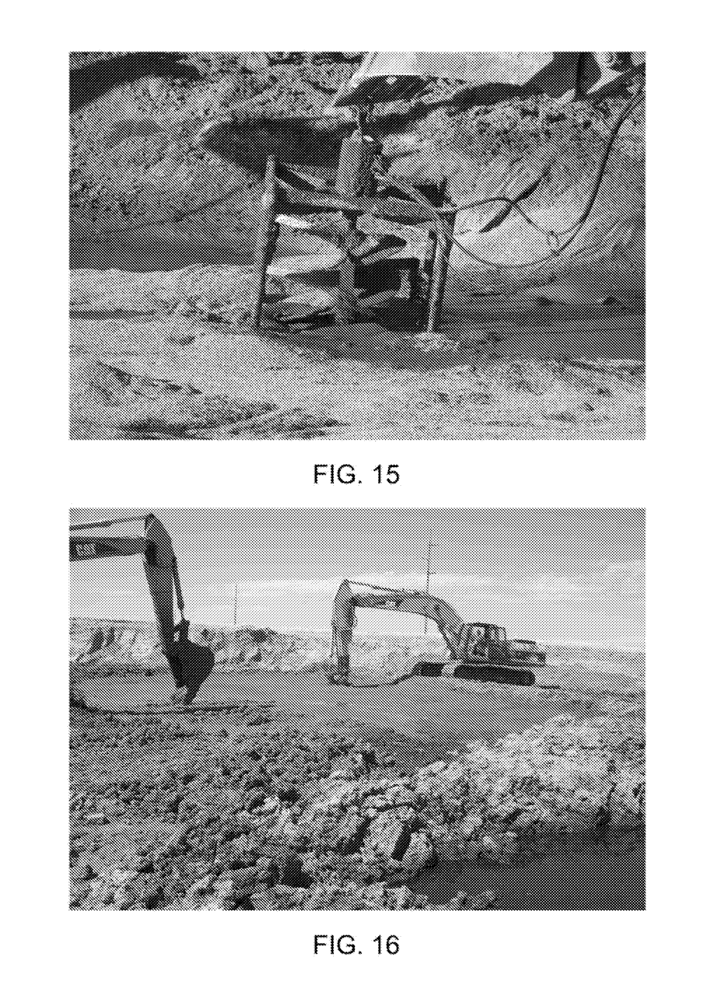

After waiting (1020) for at least a portion of the fluids other than water to be absorbed by the absorbent product and, if desired, removing (1024) accumulated water, the reserve pit remediation process (1000) may include the step of mixing (1028) the absorbent material with the solids within the reserve pit. The step of mixing (1028) may be accomplished in a variety of manners so long as sufficient mixing of the absorbent product with the solids is achieved. One suitable manner of mixing (1028) may include the steps of positioning one or more high shear-type mixing devices within the reserve pit and operating the high shear-type mixing device(s) while moving the high shear-type mixing device(s) around the pit. FIG. 14 shows one exemplary high-shear-type mixing device attached to the bucket of an excavator for positioning within the reserve pit by operating the boom of the excavator. FIG. 15 shows the exemplary high shear-type mixing device being used to mix the absorbent product and the contents of the reserve pit. Where the pit has been previously sub-divided into portions, one or more high shear-type mixing devices may be employed simultaneously in each portion, or the same high shear-type mixing device(s) may be repositioned in successive portions of the sub-divided pit. Regardless of how the step of mixing (1028) is achieved, the goal of mixing the absorbent product with the solids is to achieve a generally homogenous mixture within the pit.

The reserve pit remediation process (1000) may also include the step of allowing (1032) the reserve pit to dry for a period of time after the step of mixing (1028) is completed. While the amount of time to wait for the pit to dry may vary, it will typically be sufficient to wait for a period of as long as two days before proceeding with further steps of the reserve pit remediation process (1000).

If, after allowing (1032) the pit to dry, the surface of the pit has standing water and/or fluids other than water or the pit contents are still highly viscous, the reserve pit remediation process (1000) may include the step of adding and mixing (1036) additional absorbent product to the portions of the pit where there is standing water and/or fluid other than water or the pit contents are still highly viscous. In this regard, it may be desirable to sub-divide the pit into sections with dry backfill soil so that additional saturated solids and fluids are not drawn into an area being worked. The pit should be given an additional period of time (e.g. up to about two days), to further dry and solidify after the step of adding and mixing (1036) additional absorbent material.

The reserve pit remediation process (1000) may also include the step of placing and mixing backfill soil (1040) with the contents of the reserve pit. In this regard, backfill soil may be placed and mixed as needed in order to solidify and compact the pit. In mixing the backfill soil, an excavator bucket may, for example, be employed. FIG. 16 depicts a pair of excavators being used to place and mix backfill soil with the contents of the pit.

Throughout the reserve pit remediation process (1000) and after the final step of placing and mixing (1040) backfill soil, any additional steps required by applicable law or regulations should also be completed.

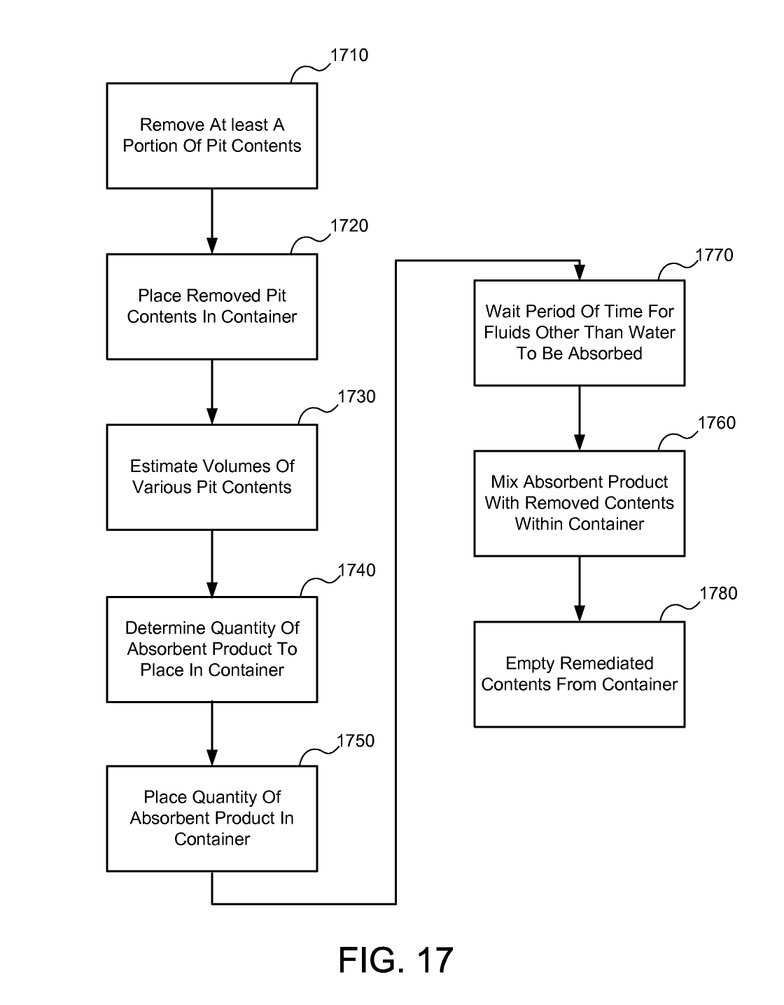

FIG. 17 depicts one embodiment of an ex-situ reserve pit remediation process (1700) that utilizes an organic absorbent product made from beetle-killed lodgepole pine to remediate and solidify to contents of a reserve pit. The absorbent product may comprise fractured portions (also referred to herein as fractured pellets or small pieces) of pellets made from beetle-killed lodgepole pine. In this regard, the absorbent product may, for example, be prepared in a manner consistent with steps (310) through (360) of the process depicted in FIG. 3, although other preparation processes may also be sufficient. Additionally, in preparing the absorbent product for use in the ex-situ reserve pit remediation process (1700), it may, for example, be desirable to electrostatically charge the fractured portions prior to use.

The ex-situ reserve pit remediation process (1700) includes the steps of removing (1710) at least a portion of the contents of the reserve pit and placing (1720) the removed contents of the reserve pit in a container. In this regard, the contents may, for example, be pumped from the pit into the container and/or excavated from the pit (e.g. using an excavator bucket) and dumped into the container.

The ex-situ reserve pit remediation process (1700) also includes estimating (1730) a volume of water within the container, a volume of fluids other than water (e.g., fracturing fluids and petroleum hydrocarbons) within the container, and/or a volume of solids (e.g., drilling mud and spoils) within the container and determining (1740) a quantity of absorbent product to be placed in the container based on the estimated volume of water, estimated volume of fluids other than water and/or estimated volume of solids placed within the container. In this regard, the appropriate quantity of absorbent product may be determined in a similar manner as with the in-situ reserve pit remediation process.

The ex-situ reserve pit remediation process (1700) also includes placing (1750) the quantity of absorbent product in the container and mixing (1760) the absorbent product with the removed contents of the reserve pit within the container. In this regard, the absorbent product may be placed in the container after the removed contents of the pit are placed in the container, while the removed contents are being placed in the container or before the removed contents are placed in the container. The absorbent product and the removed contents of the pit may be mixed (1760) within the container in any suitable manner including for example, by positioning at least one high shear-type mixing device within the container and operating the at least one high shear-type while moving the high shear-type mixing device around the container.

Additionally, the ex-situ reserve pit remediation process may also include waiting (1770) a period of time for the absorbent product to absorb at least a portion of the fluids other than water. The step of waiting may, for example, be undertaken prior to mixing the absorbent product with the removed contents of the pit. The desirable period of time to wait may vary depending on the size of the container.

The ex-situ reserve pit remediation process (1700) may also include, after a period of time, emptying (1780) the contents of the container (the absorbent product/remediated pit contents) back into the reserve pit or into a location other than the reserve pit (e.g., a dump site remote from the pit). Further, the ex-situ reserve pit remediation process (1700) may be combined with the in-situ reserve pit remediation process (1000) to remediate the same reserve pit.

The constituents and efficacy of absorbent product prepared from beetle-killed lodgepole pine that is suitable for various uses such as, for example, in-situ and/or ex-situ reserve pit remediation as described herein, has been analyzed. In this regard, analytical testing of a sample of absorbent product has indicated that the absorbent product density was 2.25 g/mL, that no organochlorine pesticides or PCBs were detected above the laboratory reporting limits, that total metals detected included trace amounts of arsenic, cadmium, chromium, copper, and zinc, and that volatile organic compounds detected just above reporting limits included p-Cymene (p-Isopropyltoluene), isopropylbenzene, styrene, and toluene. Table 2 summarizes the results of such analytical testing.

TABLE 2

| Compound | Concentration (mg/kg) |
|---|---|
| Arsenic | 0.185 |
| Cadmium | 0.185 |
| Chromium | 0.500 |
| Copper | 0.537 |
| Lead | <0.185 |
| Mercury | <0.00303 |
| Nickel | <0.463 |
| Zinc | 9.35 |
| Cyanide | <0.060 |
| Chlorinated Hydrocarbons | <0.024 |
| p-Cymene (p-Isopropyltoluene) | 5.15 |
| isopropylbenzene | 0.045 |
| styrene | 0.042 |
| toluene | 0.262 |

The efficacy of the absorbent product made from beetle-killed lodgepole pine in remediating various contaminants has been tested. In this regard, the levels of various contaminants present in soil samples before and after treatment for a period of three days with the absorbent product made from beetle-killed lodgepole pine is summarized in Table 3.

TABLE 3

| Contaminant | Level Before Treatment | Level After Treatment |
|---|---|---|
| Ethylbenzene | 0.0588 mg/Kg | 0.0054 mg/Kg |
| Benzene | 0.0066 mg/Kg | <0.002 mg/Kg |
| Naphthalene | 0.0194 mg/Kg | <0.002 mg/Kg |
| Tetrachloroethene | 0.858 mg/Kg | <0.002 mg/Kg |
| cis-1,2-Dichloroethene | 0.380 mg/Kg | <0.002 mg/Kg |
| 1,2,4- | 0.115 mg/Kg | 0.0202 mg/Kg |
| Trimethylbenzene | | |
| Arsenic | 0.68 mg/Kg | <0.5 mg/L |
| Cadmium | 0.459 mg/Kg | <0.10 mg/L |
| Chromium | 16.3 mg/Kg | <0.5 mg/L |
| Lead | 16.0 mg/Kg | <0.5 mg/L |
| Barium | 162 mg/Kg | <10.0 mg/L |

Additionally, before and after salinity test results obtained for a brine solution mixed in a 50/50 ratio with the absorbent product are summarized in Table 4.

TABLE 4

| | Before Treatment | After Treatment |
|---|---|---|
| Salinity (calculated) | 206 | 60.9 |
| Magnesium | 4 meq/L | Non Detect |
| Calcium | 413 meq/L | 188 meq/L |
| Sodium | 3200 meq/L | 792 meq/L |
| Sodium Absorption | 220 | 81 |
| Ratio | | |

The above-noted noted efficacy of the absorbent product prepared from beetle-killed lodgepole pine is believed to be due at least in part to monoterpene and diterpene biosysthensis that occurs in lodgepole pine trees that become infected with blue-stain fungus Ceratocystis claivigera. Mountain bark beetles dendrocotonus ponderosae are known to carry blue-stain fungus Ceratocystis claivigera in their mouths thereby spreading the fungus from tree-to-tree. Studies have indicated that elevated levels of monoterpenes and diterpene resin acids are produced in lodgepole pine saplings when wounded and inoculated with blue-stain fungus Ceratocystis claivigera. This induced defensive response (hyperoleoresinosis) in the lodgepole pines is the result of a transient rise in the ability to biosynthesize cyclic monoterpenes and diterpene resin acids and is accompanied by a corresponding rise in the levels of terpene cyclases.

As mentioned, the absorbent product prepared from beetle-killed lodge pole pine is useful to absorb and remediate various contaminates including, for example, both petroleum hydrocarbon contaminated soils and spilled petroleum hydrocarbons. While different situations may require application of different amounts of absorbent product, a calculator has been developed and implemented in spreadsheet software executable by a personal computer or the like to compute recommendations based upon various inputs to the calculator. For petroleum hydrocarbon contaminated soils, a user of the calculator enters a petroleum hydrocarbon concentration level, the area contaminated, and the depth of contaminated soil. The calculator then generates an amount of absorbent product to apply to the contaminated soil along with 10% contingency and 20% contingency amounts as well. In this regard, Table 5 outlines exemplary recommended amounts of absorbent product to use to treat petroleum hydrocarbon contaminated soil generated by the calculator for particular petroleum hydrocarbon concentration level, contaminated area, and the depth of contaminated soil inputs.

TABLE 5

| Oil | Contam- | | | Pallets | |
|---|---|---|---|---|---|
| Concentration | inated | Depth of | Absorbent | of | |
| in Soil | Area | Contamination | product | 25# | Super |
| (mg/kg) | (Sq. ft.) | (ft.) | (pounds) | Sacks | Sacs |
| 38,000 | 5,625 | 3 | 110,991 | 59.2 | 55.5 |
| | | 10% | 122,090 | 65.1 | 61.0 |
| | | Contingency | | | |
| | | 20% | 133,189 | 71.0 | 66.6 |
| | | Contingency | | | |

For spilled petroleum hydrocarbons, a user of the calculator enters a volume of the spilled petroleum hydrocarbons, and the calculator generates an amount of absorbent product to apply to the spilled petroleum hydrocarbons. In this regard, Table 6 outlines an exemplary recommended amount of absorbent product to use to treat spilled petroleum hydrocarbons generated by the calculator for a particular volume of spilled petroleum hydrocarbons input.

TABLE 6

| Volume of | Absorbent | | | |
|---|---|---|---|---|
| Spill | product | Number of | Pallets of | Super |
| (gallons) | (pounds) | 25# Sacks | 25# Sacks | Sacs |
| 100 | 1,060 | 42 | 0.6 | 0.5 |

As shown in Tables 5 and 6, the recommended amounts of absorbent product output by the calculator may be expressed in a number of manners including, for example, in total pounds or kilograms of absorbent product, in a number of 25 pound sacks of absorbent product, in a number of pallets of 25 pound sacks, and/or in a number of Super Sacs (2000+/−pound sacks) of absorbent product.

When applying the absorbent product prepared from beetle-killed lodge pole pine to absorb and remediate contaminated soils, particular ambient conditions may be desirable. For example, a preferred ambient air temperature is any temperature greater than 32 degrees Fahrenheit and a minimum soil temperature is 20 degrees Fahrenheit and rising. In general colder temperatures can slow down the reaction time of the product, and the absorbent product may not be effective when frozen. Soil moisture content may dictate how much to hydrate the product prior to applying to contaminated soils. For example, saturated soil (e.g. mud) may not require any prior hydration of the product; whereas, dry soil may require that the absorbent product be hydrated with water in a 1:1 ratio.

For contaminated soil that has been excavated, mixing of the soil with absorbent product may take place in an enclosed container or specialty soil mixer. In this regard, a premeasured quantity of absorbent product and water (if needed) may first be added to the mixer and then the contaminated soil may slowly be added while the mixing augers are turning. The quantity of absorbent product, water (if needed) and mixing time generally depends on concentrations of contaminates found in the soil. Pre-testing of the soil is preferred to determine mixing ratios (e.g. using the spread sheet calculator).

Test samples of DRO contaminated soils have been obtained from several farm land locations and treated with the absorbent product prepared from beetle-killed lodge pole pine. Each farm land location (identified as the LAC 5, LAC 10, West Compost and East Compost locations) had varying levels of oil contamination and age of contamination. In a first series of tests, equal masses of contaminated soil were placed in mixing trays. Absorbent product was hydrated with tap water in a separate container. The absorbent product was allowed to hydrate for approximately two minutes before being thoroughly hand mixed with the contaminated soil samples. Contaminated soil was mixed with hydrated absorbent product at ratios of one to one and two parts absorbent product to one part contaminated soil. The test samples were kept hydrated with tap water for two days. The samples were then allowed to dry for one day. Representative grab samples were collected and analyzed for DRO levels (before and after treatment) and total extractable hydrocarbons (EPA Method 8051B). Table 7 summarizes the results of such analysis for the four sample locations.

TABLE 7

| | | 1:1 Mix Ratio | | 2:1 Mix Ratio | |
|---|---|---|---|---|---|
| | Untreated | Treated | | Treated | |
| Location | DRO | DRO | % Reduction | DRO | % Reduction |
| LAC 5 | 110,000 mg/kg | 34,900 mg/kg | 68.3% | 14,800 mg/kg | 86.5% |
| LAC 10 | 8,360 mg/kg | 5,980 mg/kg | 28.5% | 4,560 mg/kg | 45.5% |
| West | 11,300 mg/kg | 6,890 mg/kg | 39.0% | 2,940 mg/kg | 74.0% |
| Compost | | | | | |
| East | 8,550 mg/kg | 3,820 mg/kg | 55.3% | 4,00 mg/kg | 53.2% |
| Compost | | | | | |

When evaluating the report data, it should be understood that the EPA 8051B test methodology uses solvent to extract hydrocarbons from the soil for analysis. Solvents will dissolve hydrocarbons upon contact. Therefore, the results provide an indication to the ability of the absorbent product to retain absorbed petroleum hydrocarbons that would otherwise remain absorbed by the absorbent product in the environment. The results also indicate that absorbent product interaction with contaminated soil may be critical. Visually, the absorbent product did not appear to have reached oil saturation during the tests. It may be inferred that some of the hydrocarbons extracted were from soil that did not receive complete mixing.

In a second series of tests, a new set of soil grab samples were collected from the same four farm land locations. The contact time between the absorbent product and the contaminated soil was reduced to just two hours. The mix ratio was one pound absorbent product to one pound contaminated soil. Representative grab samples were collected and analyzed for DRO levels (before and after treatment) and total extractable hydrocarbons (EPA Method 8051B). Table 8 summarizes the results of such analysis of the second series for the four sample locations.

TABLE 8

| | | 1:1 Mix Ratio | |
|---|---|---|---|
| Location | Untreated DRO | Treated DRO | % Reduction |
| LAC 5 | 206,000 mg/kg | 63,800 mg/kg | 69.0% |
| LAC 10 | 25,100 mg/kg | 3,810 mg/kg | 84.8% |
| West Compost | 11,800 mg/kg | 4,430 mg/kg | 62.4% |
| East Compost | 8,490 mg/kg | 4,530 mg/kg | 46.6% |

The DRO removal percentages for the two series of tests for the four farm land locations are summarized in Table 9.

TABLE 9

| | 3-Days | 2-Hours |
|---|---|---|
| Location | Treated DRO Reduction | Treated DRO Reduction |
| LAC 5 | 68.3% | 69.0% |
| LAC 10 | 28.5% | 84.8% |
| West Compost | 39.0% | 62.4% |
| East Compost | 55.3% | 46.6% |

Comparing the percentage of DRO reduction between the two series of tests, LAC 5 and East Compost showed consistent contaminate removal percentages. These results indicate that the absorption process occurs quickly and that additional contact time may not increase the amount of contamination removed from the soil. DRO removal percentages for LAC 10 and West Compost locations showed a considerable increase in the amount of DRO absorbed from the soil by the absorbent product. The increased removal percentages may be due to changes in the chemical composition of soil contamination. But, as proper mixing may be critical, the second series of tests most likely had complete product mixing with the contaminated soil.

A sample of lead contaminated soil has been obtained from a former shooting range and treated with the absorbent product prepared from beetle-killed lodge pole pine. Residual lead pellets were removed from the soil and the soil sample was collected to represent a worst case scenario, soils near a target box. The base soil was analyzed for total lead and had a reported concentration of 13,400 mg/kg (EPA Method 6010, preparation Method EPA 3050). Three equal mass test samples of the base soil were prepared, each weighing one pound. Next, three varying portions of dehydrated absorbent product were weighed for conducting three tests. Test 1 contained amounts of absorbent product and contaminated soil. Test 2 contained two pounds of absorbent product to one pound of contaminated soil. Test 3 contained three pounds of absorbent product to one pound of contaminated soil. In each test, the absorbent product was hydrated with tap water in a separate container. The absorbent product was allowed to hydrate for approximately two minutes before being mixed with the contaminated soil. After two minutes of mixing the hydrated absorbent product with the contaminated soil, the samples of the treated soil were analyzed for lead concentration. Table 10 summarizes the results of such testing.

TABLE 10

| Mixture ratio | TCLP Lead Concentration | % Reduction |
|---|---|---|
| Base | 48.2 mg/L | — |
| Test 1 (1:1) | 6.7 mg/L | 86% |
| Test 2 (1:2) | 2.7 mg/L | 94% |
| Test 3 (1:3) | 1.9 mg/L | 96% |

The data collected clearly shows that the absorbent product is effective at removing lead contamination from soil. Subsequent experiments have indicated that if the hydration water is introduced to the contaminated soil and absorbent product mixture (soil washing), a greater lead removal level is expected.

A sample of industrial sludge has been obtained from a drain sump of a former diesel technology training center and treated with the absorbent product prepared from beetle-killed lodge pole pine. The sample solution had a high suspended solid content. The base liquid was analyzed for the ‘RCRA Eight’ metals (Arsenic, Barium, Cadmium, Chromium, Lead, Selenium, Silver and Mercury). Due to high solids content, a 30/50 digestion was performed. Absorbent product was hydrated with tap water and added to a mixing vessel, which contained one pound of the sample liquid, until the liquid was completely absorbed. Approximately one pound of hydrated absorbent product was required to absorb the liquid. In this test, the absorbent product was hydrated with tap water in a separate container. The absorbent product was allowed to hydrate for approximately two minutes before being mixed with the sample liquid. After one minute of mixing the absorbent product with the liquid to ensure complete absorption, a sample of spent absorbent product was analyzed for the RCRA Eight metals. Table 11 summarizes the results of such analysis.

TABLE 11

| Constituent | Raw Total Metals | Treated TCLP Metals |
|---|---|---|
| Arsenic | 2 mg/kg | Not Detected |
| Barium | 44.2 mg/kg | Not Detected |
| Cadmium | 2 mg/kg | Not Detected |
| Chromium | Not Detected | Not Detected |
| Lead | 20 mg/kg | Not Detected |
| Selenium | 2.8 mg/kg | Not Detected |
| Silver | Not Detected | Not Detected |
| Mercury | Not Detected | Not Detected |

Another use of the absorbent product prepared from beetle-killed lodge pole pine is to absorb most fluids including acids. Once dried, the absorbed acid can be safely handled and disposed. As the absorbent product is a cellulose based product, caution should be used when working with strong oxidizers such as concentrated bleach, hydrogen peroxide and oxidizing acids like nitric and chromic acid. In situations that demand acid neutralization before cleanup, the absorbent product prepared from beetle-killed lodge pole pine may be applied dry directly on spilled acid to quickly neutralize and dry acid spills for easy-clean-up without a vigorous chemical reaction. In this regard, the absorbent product has been found to neutralize most typical acids, such as sulfuric (H2So4; 10% and 50% concentration) and hydrochloric (HCL; 10% and 20% concentration).

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A method for in-situ remediation of a reserve pit, said method comprising the steps of:
estimating one or more of a volume of water within the pit, a volume of fluids other than water within the pit, and a volume of solids within the pit;
determining a quantity of absorbent product to be distributed within the pit based on one or more of the estimated volume of water, estimated volume of fluids other than water and estimated volume of solids, wherein the absorbent product comprises fractured portions of pellets made from beetle-killed lodgepole pine;
distributing the quantity of absorbent product over the surface of the reserve pit;
waiting a period of time for the absorbent product to absorb at least a portion of the fluids other than water; and
mixing the absorbent product with the solids within the reserve pit.

2. The method of claim 1 wherein the fluids other than water include fracturing fluids and petroleum hydrocarbons.

3. The method of claim 1 wherein the solids include drilling mud and spoils.

4. The method of claim 1 wherein said estimating comprises:
establishing a total volume of the pit;
measuring a depth of one or more of the water within the pit, the fluids other than water within the pit, and the solids within the pit; and
using the measured depths and the total volume of the pit to determine one or more of the volume of water within the pit, the volume of fluids other than water within the pit, and the volume of solids within the pit.

5. The method of claim 1 wherein in said determining a quantity of absorbent product, a volume of said determined quantity of absorbent product plus the estimated volume of solids within the pit does not exceed one-half of the total volume of the pit.

6. The method of claim 1 further comprising:
removing at least a portion of the water prior to said step of distributing the quantity of absorbent product.

7. The method of claim 1 wherein in said step of distributing, the absorbent product is evenly distributed over the surface of the pit.

8. The method of claim 1 wherein in said step of waiting a period of time, the period of time comprises up to two days.

9. The method of claim 1 further comprising:
removing at least a portion of accumulated water from the surface of the pit prior to said mixing step.

10. The method of claim 1 wherein said mixing step comprises:
positioning at least one high shear-type mixing device within the reserve pit; and
operating the at least one high shear-type while moving the high shear-type mixing device around the pit.

11. The method of claim 10 wherein in said step of operating, high shear-type mixing device is operated at a desired rotational speed in the range of about 91 rpm to about 111 rpm.

12. The method of claim 1 further comprising:
allowing the reserve pit to dry for a period of time; and
placing and mixing backfill soil with contents of the reserve pit.

13. The method of claim 12 further comprising:
adding and mixing an additional quantity of the absorbent product to the reserve pit prior to said step of adding and mixing backfill soil.

14. The method of claim 1 further comprising:
obtaining pellets made from various portions of beetle-killed lodgepole pine; and
processing the pellets to prepare fractured pellets.

15. The method of claim 14 wherein said step of processing the pellets to prepare fractured pellets comprises grinding the pellets.

16. The method of claim 15 further comprising:
screening the ground pellets to select fractured portions within a desired range of sizes.

17. The method of claim 16 wherein, in said step of screening, the desired range of sizes is about ⅛ inch to about ¼ inch.

18. The method of claim 14 wherein said step of obtaining comprises:
selecting various portions of beetle-killed lodgepole pine;
processing the selected portions into grist;
drying the grist; and
pelletizing the grist to form pellets.

19. The method of claim 18 wherein said step of selecting comprises selecting one or more of the bark, sawdust, trunk, larger branches and chips from beetle-killed lodgepole pine.

20. The method of claim 19 wherein said step of selecting further comprises excluding small branches and needles from the beetle-killed lodgepole pine.

21. The method of claim 18 wherein said step of pelletizing the grist to form pellets comprises compressing the pellets to a density in the range of about 40 to 46 pounds per cubic foot.

22. The method of claim 18 wherein said step of drying comprises drying the grist to a maximum moisture content of less than or equal to about 6 percent by weight.

23. The method of claim 14 further comprising:
electrostatically charging the fractured portions.

24. A method for in-situ remediation of a reserve pit, said method comprising the steps of:
distributing a quantity of an absorbent product over the surface of the reserve pit, wherein the absorbent product comprises fractured pellets made from various portions of beetle-killed lodgepole pine; and
mixing the absorbent product with the contents of the reserve pit.

25. An organic absorbent product for use reserve pit remediation, said product comprising:
fractured portions of pellets made from beetle-killed lodgepole pine, wherein the fractured portions are within a desired range of sizes.

26. The organic absorbent product of claim 25 wherein the desired range of sizes is from about ⅛ inch to about ¼ inch.

27. The organic absorbent product of claim 25 wherein the fractured portions are electrostatically charged.

28. The organic absorbent product of claim 25 wherein the pellets have been compressed to a density in the range of about 40 to 46 pounds per cubic foot.

29. The organic absorbent product of claim 28 wherein the pellets have maximum moisture content of less than or equal to about 6 percent by weight.

30. The organic absorbent product of claim 25 wherein the portions of beetle-killed lodgepole pine include at least one of bark, sawdust, trunk, larger branches and chips.

31. The organic absorbent product of claim 30 wherein the portions of beetle-killed lodgepole pine exclude small branches and needles.

32. A method for ex-situ remediation of a reserve pit, said method comprising the steps of:
removing at least a portion of the contents of the reserve pit;
placing the removed contents of the reserve pit in a container;
placing a quantity of an absorbent product in the container, wherein the absorbent product comprises fractured pellets made from various portions of beetle-killed lodgepole pine; and
mixing the absorbent product with the removed contents of the reserve pit within the container.

33. The method of claim 32 further comprising:
estimating one or more of a volume of water within the container, a volume of fluids other than water within the container, and a volume of solids within the container; and
determining a quantity of absorbent product to be placed in the container based on one or more of the estimated volume of water, estimated volume of fluids other than water and estimated volume of solids.

34. The method of claim 33 wherein the fluids other than water include fracturing fluids and petroleum hydrocarbons.

35. The method of claim 33 wherein the solids include drilling mud and spoils.

36. The method of claim 32 further comprising:
waiting a period of time for the absorbent product to absorb at least a portion of the fluids other than water.

37. The method of claim 32 wherein said step of mixing comprises:
positioning at least one high shear-type mixing device within the container; and
operating the at least one high shear-type while moving the high shear-type mixing device around the container.

38. The method of claim 37 wherein in said step of operating, high shear-type mixing device is operated at a desired rotational speed in the range of about 91 rpm to about 111 rpm.

39. The method of claim 32 wherein said steps of removing at least a portion of the contents of the reserve pit and placing the removed contents in a container comprise pumping the removed contents from the pit into the container.

40. The method of claim 32 wherein said steps of removing at least a portion of the contents of the reserve pit and placing the removed contents in a container comprise excavating the removed contents from the pit and dumping the removed contents in the container.
